(19) United States
(12) Patent Application Publication
(10) Pub. No.: US 2025/0104721 A1
(43) Pub. Date: Mar. 27, 2025

(54) AUDIO PROCESSING METHOD USING COMPLEX NUMBER DATA, AND APPARATUS FOR PERFORMING SAME

(71) Applicant: ELECTRONICS AND TELECOMMUNICATIONS RESEARCH INSTITUTE, Daejeon (KR)

(72) Inventors: Seung Kwon BEACK, Daejeon (KR); Jongmo SUNG, Daejeon (KR); Tae Jin LEE, Daejeon (KR); Woo-taek LIM, Daejeon (KR); Inseon JANG, Daejeon (KR); Byeongho CHO, Daejeon (KR)

(73) Assignee: ELECTRONICS AND TELECOMMUNICATIONS RESEARCH INSTITUTE, Daejeon (KR)

(21) Appl. No.: 18/686,568

(22) PCT Filed: Dec. 15, 2022
(86) PCT No.: PCT/KR2022/020434

§ 371 Date: Feb. 26, 2024

(30) Foreign Application Priority Data
Dec. 15, 2021 (KR) 10-2021-0179742
Dec. 13, 2022 (KR) 10-2022-0173938

(51) Int. Cl. G10L 19/032; G10L 19/03

(52) U.S. Cl. CPC G10L 19/032; G10L 19/03

(57) ABSTRACT

Disclosed are a device and method for audio signal processing. The audio signal processing device according to an embodiment includes a receiver configured to receive a bitstream corresponding to a compressed audio signal and a processor. The processor may be configured to generate a real restoration signal or a complex restoration signal by performing inverse quantization on real data of the bitstream or complex data of the bitstream, generate a result of real Frequency Domain Noise Shaping (FDNS) synthesis or a result of complex FDNS synthesis by performing FDNS synthesis on the real restoration signal or the complex restoration signal, and generate a restored audio signal by performing frequency-to-time transform on the result of the real FDNS synthesis or the result of the complex FDNS synthesis.

### TECHNICAL FIELD

The following description relates to a device and method for processing an audio signal.

### BACKGROUND ART

Audio coding is a technique for compressing an audio signal and transmitting the compressed audio signal. Audio coding has improved compression performance over several generations.

The audio coding technique of the first-generation Moving Picture Experts Group (MPEG) has been developed by designing a quantizer based on a human psychoacoustic model and compressing data in order to minimize perceptual loss of sound quality.

The audio coding technique of the second-generation MPEG-2 Advanced Audio Coding (AAC) has some structural constraints that require a process of transforming a hybrid frequency that combines Quadrature Mirror Filterbank (QMF) and Modified Discrete Cosine Transform (MDCT) so as to provide backward compatibility with existing layers.

An MPEG-4 parametric coding technique, which is a third-generation MPEG audio coding technique, has achieved remarkable compressibility at low bit rates but still has required AAC 128 kbps to provide high sound quality.

A Unified Speech and Audio Coding (USAC) technique, which is fourth-generation MPEG audio coding technology, has been developed to improve sound quality of low bit rate audio that had not been dealt with in MPEG before.

### DISCLOSURE OF THE INVENTION

### Technical Solutions

An audio signal processing device according to an embodiment includes a receiver configured to receive a bitstream corresponding to a compressed audio signal and a processor. The processor may be configured to generate a real restoration signal or a complex restoration signal by performing inverse quantization on real data of the bitstream or complex data of the bitstream, generate a result of real Frequency Domain Noise Shaping (FDNS) synthesis or a result of complex FDNS synthesis by performing FDNS synthesis on the real restoration signal or the complex restoration signal, and generate a restored audio signal by performing frequency-to-time transform on the result of the real FDNS synthesis or the result of the complex FDNS synthesis.

The processor may be configured to generate the complex restoration signal by performing the inverse quantization on the real data and the complex data, based on a same scale factor.

The processor may be configured to perform Temporal Noise Shaping (TNS) synthesis or the FDNS synthesis on the complex restoration signal by controlling a first switch based on a first switch control signal.

When the complex restoration signal is a TNS residual signal, the processor may be configured to perform the TNS synthesis on the complex restoration signal and perform the FDNS synthesis on a result of the TNS synthesis.

When the complex restoration signal is an FDNS residual signal, the processor is configured to perform the complex FDNS synthesis on the complex restoration signal.

The processor may be configured to perform complex inverse quantization or real inverse quantization on the bitstream by controlling a second switch based on a second switch control signal.

The processor may be configured to perform switching compensation on a result of the frequency-to-time transform.

The processor may be configured to determine whether a signal corresponding to a current frame of the result of the frequency-to-time transform is a Time Domain Aliasing (TDA) signal and perform overlap-add based on a result of determining whether the signal is the TDA signal.

The processor may be configured to determine whether a signal corresponding to a previous frame of the result of the frequency-time transform is the TDA signal and perform the overlap-add based on a result of determining whether the signal corresponding to the previous frame is the TDA signal.

A method of processing an audio signal according to an embodiment may include receiving a bitstream corresponding to a compressed audio signal, generating a real restoration signal or a complex restoration signal by performing inverse quantization on real data of the bitstream or complex data of the bitstream, generating a result of real Frequency Domain Noise Shaping (FDNS) synthesis or a result of complex FDNS synthesis by performing FDNS synthesis on the real restoration signal or the complex restoration signal, and

generating a restored audio signal by performing frequency-to-time transform on the result of the real FDNS synthesis or the result of the complex FDNS synthesis.

The generating of the real restoration signal or the complex restoration signal may include generating the complex restoration signal by performing inverse quantization on the real data and the complex data based on a same scale factor.

The generating of the result of the real FDNS synthesis or the result of the complex FDNS synthesis may include performing Temporal Noise Shaping (TNS) synthesis or the FDNS synthesis on the complex restoration signal by controlling a first switch based on a first switch control signal.

The performing of the TNS synthesis or the FDNS synthesis on the complex restoration signal may include, when the complex restoration signal is a TNS residual signal, performing the TNS synthesis on the complex restoration signal and performing the FDNS synthesis on a result of the TNS synthesis.

The generating of the result of the real FDNS synthesis or the result of the complex FDNS synthesis may include performing the complex FDNS synthesis on the complex restoration signal when the complex restoration signal is an FDNS residual signal.

The generating of the real restoration signal or the complex restoration signal may include performing complex inverse quantization or real inverse quantization on the bitstream by controlling a second switch based on a second switch control signal.

The audio signal processing method may further include performing switching compensation on a result of the frequency-to-time transform.

The performing of the switching compensation may include determining whether a signal corresponding to a current frame of the result of the frequency-time transform is a Time Domain Aliasing (TDA) signal and performing overlap-add based on a result of determining whether the signal is the TDA signal.

The performing of the overlap-add based on the result of determining whether the signal is the TDA signal may include determining whether a signal corresponding to a previous frame of the result of the frequency-to-time transform is the TDA signal and performing the overlap-add based on a result of determining whether the signal corresponding to the previous frame is the TDA signal.

An audio signal processing device according to another embodiment may include a receiver configured to receive an audio signal and a processor. The processor may be configured to generate a real transform spectrum or a complex transform spectrum by performing time-to-frequency transform on the audio signal, generate a real residual signal or a complex residual signal by performing Frequency Domain Noise Shaping (FDNS) analysis on the real transform spectrum or the complex transform spectrum, and generate a bitstream corresponding to a compressed audio signal by performing quantization on the real residual signal or the complex residual signal.

### BRIEF DESCRIPTION OF DRAWINGS

FIG. 1 is a block diagram illustrating an audio processing system according to an embodiment.

FIG. 2 is a schematic block diagram of an encoder illustrated in FIG. 1.

FIG. 3 is a schematic block diagram of a decoder illustrated in FIG. 1.

FIG. 4 is another example of the encoder illustrated in FIG. 2.

FIG. 5 is an example of a graph illustrating a complex Temporal Noise Shaping (TNS) gain.

FIG. 6 is another example of a graph illustrating a complex TNS gain.

FIG. 7 is an example of implementation of the decoder illustrated in FIG. 3.

FIG. 8 is a diagram illustrating a switching compensation operation shown in FIG. 7.

FIG. 9 is an example of an overlap-add operation.

FIG. 10 is another example of an overlap-add operation.

FIG. 11 is a diagram illustrating a quantization process.

FIG. 12 is a diagram illustrating an inverse quantization process.

FIG. 13 is an example of performance of an audio processing device.

FIG. 14 is another example of performance of an audio processing device.

FIG. 15 is a flowchart of an operation of the decoder illustrated in FIG. 1.

### BEST MODE FOR CARRYING OUT THE INVENTION

The following structural or functional descriptions of examples are merely intended for the purpose of describing the examples and the examples may be implemented in various forms. Here, examples are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, 10 “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. As used herein, “A or B”, “at least 15 one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/including” and/or “includes/including” when used herein, specify the presence of stated features, integers, operations, operations, 20 elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art 25 to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include 30 a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an example, the module may be implemented in a form of an application-specific integrated circuit (ASIC).

The term “unit” or the like used herein may refer to a software or hardware component, such as a field-programmable gate array (FPGA) or an ASIC, and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, the examples will be described in detail with reference to the accompanying drawings. When describing the embodiments with reference to the accompanying drawings, like reference numerals refer to like constituent elements and a repeated description related thereto will be omitted.

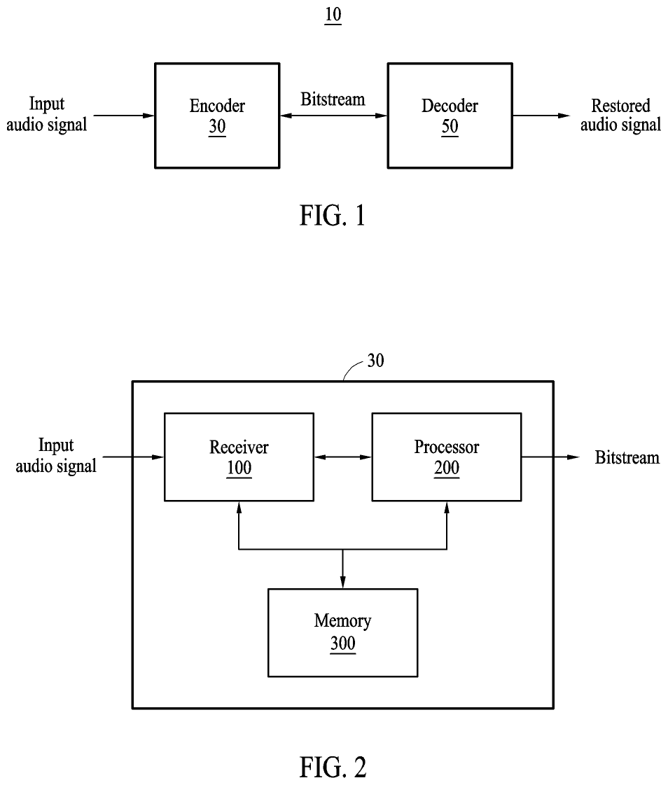

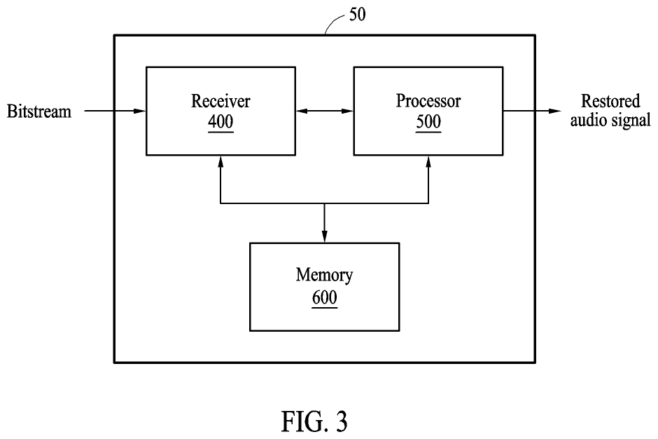

FIG. 1 is a schematic block diagram of an audio signal processing system according to an embodiment, FIG. 2 is a schematic block diagram of an encoder shown in FIG. 1, and FIG. 3 is a schematic block diagram of a decoder shown in FIG. 1.

Referring to FIGS. 1 to 3, an audio signal processing system 10 may process an audio signal. The audio signal may include an analog signal and/or a digital signal corresponding to sound.

The audio signal processing system 10 may generate a bitstream by encoding the audio signal. The audio signal processing system 10 may decode the bitstream to restore the audio signal.

The audio signal processing system 10 may perform audio compression by expressing audio data with the minimum amount of information without deteriorating sound quality and transforming the audio data into a bit string. The audio signal processing system 10 may compress the amount of information on a frequency axis and a time axis in order to represent the audio data with the minimum amount of a bit string without deterioration of sound quality.

The audio signal processing system 10 may perform data transform on real data and complex data. The audio signal processing system 10 may completely preserve a frequency domain by accurately estimating or removing time/frequency information of the real data and the complex data.

The audio signal processing system 10 may perform audio encoding or audio decoding based on a complex transform method. The audio signal processing system 10 may reduce the amount of information without distortion by effectively quantizing the amount of data that increases due to the use of complex data and by reducing the time/frequency information in a complex domain.

The audio signal processing system 10 may include an encoder 30 and a decoder 50. The encoder 30 may encode an audio signal. The encoder 30 may generate a bitstream by encoding an input audio signal. The decoder 50 may restore the audio signal. The decoder 50 may decode the bitstream to generate a restored audio signal.

The audio signal processing system 10 may be implemented by an audio signal processing device. The audio signal processing device may include at least one of the encoder 30 and the decoder 50.

The encoder 30 may include a receiver 100 and a processor 200. The encoder 30 may further include a memory 300. The decoder 50 may include a receiver 400 and a processor 500. The decoder 50 may further include a memory 600.

The receiver 100 and the receiver 400 may include a receiving interface. The receiver 100 may receive an audio signal. The receiver 100 may output the received audio signal to the processor 200. The receiver 400 may receive a bitstream corresponding to a compressed audio signal. The receiver 400 may output the received bitstream to the processor 500.

The processor 200 and/or the processor 500 may process data stored in the memory 300 and/or the memory 600. The processor 200 and/or the processor 500 may execute computer-readable code (for example, software) stored in the memory 300 and/or the memory 600 and instructions triggered by the processor 200 and/or the processor 500.

The processor 200 and/or the processor 500 may be data processing devices implemented by hardware including a circuit having a physical structure to perform desired operations. For example, the desired operations may include code or instructions in a program.

For example, the hardware-implemented data processing device may include a microprocessor, a CPU, a processor core, a multi-core processor, a multiprocessor, an ASIC, and an FPGA.

The memory 300 and/or the memory 600 may store data for an operation or an operation result. The memory 300 and/or the memory 600 may store instructions (or programs) executable by the processor 200 and/or the processor 500. For example, the instructions may include instructions for executing an operation of the processor and/or instructions for performing an operation of each component of the processor.

The memory 300 and/or the memory 600 may be implemented as a volatile memory device or a non-volatile memory device.

The volatile memory device may be implemented as dynamic random-access memory (DRAM), static random-access memory (SRAM), thyristor RAM (T-RAM), zero capacitor RAM (Z-RAM), or twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate Memory (NFGM), a holographic memory, a molecular electronic memory device, or an insulator resistance change memory.

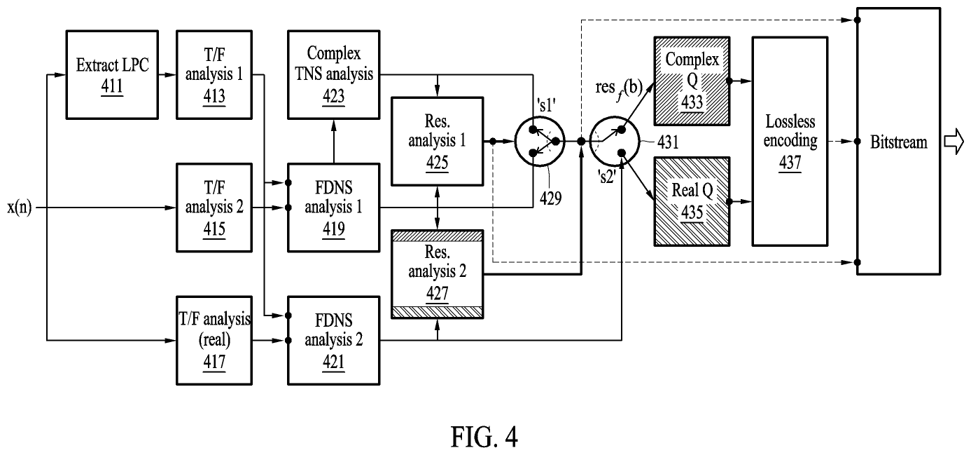

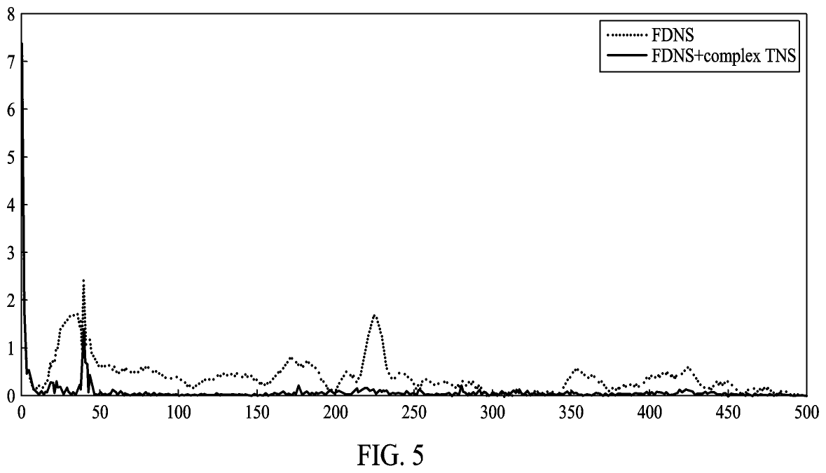

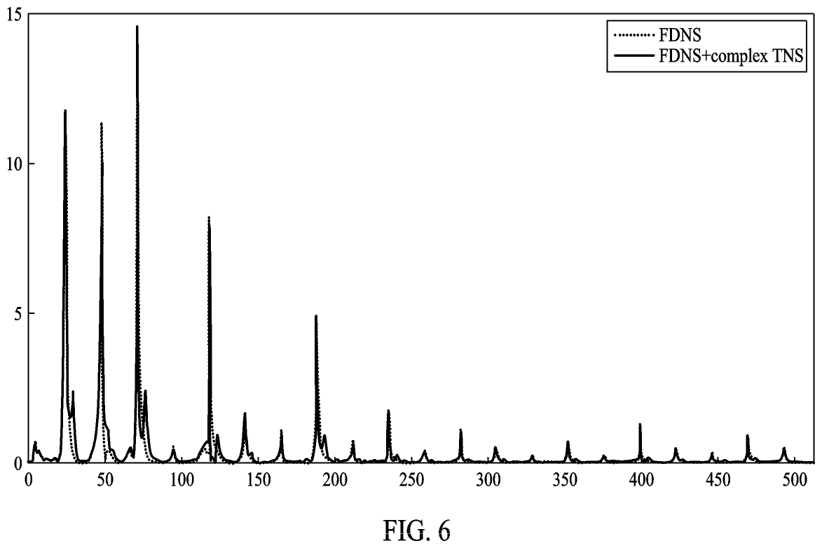

FIG. 4 is an implementation example of the encoder illustrated in FIG. 2, FIG. 5 is an example of a graph illustrating a complex Temporal Noise Shaping (TNS) gain, and FIG. 6 is another example of a graph illustrating a complex TNS gain.

Referring to FIGS. 4 to 6, a processor (e.g., the processor 200 of FIG. 2) may compress an audio signal. The processor 200 may generate a bitstream by encoding an audio signal.

The processor 200 may generate a real transform spectrum or a complex transform spectrum by performing time-to-frequency transform on the audio signal. The real transform spectrum and/or the complex transform spectrum may include a Linear Prediction Coefficients (LPC) spectrum described below.

The processor 200 may perform Frequency Domain Noise Shaping (FDNS) analysis on the real transform spectrum or the complex transform spectrum and thus generate a real residual signal or a complex residual signal.

The processor 200 may generate a bitstream corresponding to a compressed audio signal by performing quantization on the real residual signal or the complex residual signal.

The processor 200 may include an LPC extraction module 411, a time-to-frequency (T/F) analysis 1 module 413, a T/F analysis 2 module 415, a T/F analysis (real) module 417, an FDNS analysis 1 module 419, an FDNS analysis 2 module 421, a complex TNS analysis module 423, a residual analysis 1 module 425, a residual analysis 2 module 427, a first switch 429, a second switch 431, a complex Q module 433, a real Q module 435, and a lossless encoding module 437.

The processor 200 may perform time-to-frequency transform on an audio signal x(n). The processor 200 may use a complex time-to-frequency transform by using a Discrete Fourier Transform (DFT) and/or a real time-to-frequency transform by using a Modified Discrete Cosine Transform (MDCT) and thus perform the time-to-frequency transform.

The processor 200 may extract LPC from the audio signal through the LPC extraction module 411. The T/F analysis 1 module 413 may generate an LPC spectrum by performing DFT.

LPC may be defined as in Equation 1.

$$lp ( b ) = {[ lp ( 0 , b ) , lp ( 1 , b ) , … , lp ( order - 1 , b ) ]}^{T} \qquad [ Equation 1 ]$$

Here, the order may denote the order of the LPC and b may denote a block or a frame index. The T/F analysis 1 module 413 may transform lp(b) into a frequency signal. The T/F analysis 1 module 413 may perform time-to-frequency transform as shown in Equation 2.

$${lp}_{f} ( b ) = DFT \{ lp ( b ) , N or M \} \qquad [ Equation 2 ]$$

Here, DFT{ } may denote a DFT transform operation. The T/F analysis 1 module 413 may transform lp(b) by determining the number of DFT coefficients according to a frame size N of an audio signal or the number M of sub-bands.

The T/F analysis 2 module 415 may perform DFT transform by using a complex transform. The T/F analysis 2 module 415 may perform the DFT transform on the audio signal as shown in Equation 3.

$$x ( b ) = {[ x ( 0 , b ) , x ( 1 , b ) , … , x ( N - 1 , b ) ]}^{T} , \\ {x}_{f} ( b ) = DFT \{ x ( b ) ⊙ win ( b ) \} \qquad [ Equation 3 ]$$

Here, N may denote a frame size, win(b) may denote a window function applied when the audio signal is transformed into a frequency signal, and an operator ⊙ may denote an operator performing multiplication for each element.

The T/F analysis (real) module 417 may perform MDCT transform by using a real transform. The T/F analysis (real) module 417 may perform MDCT transform as shown in Equation 4.

$${x}_{{f}_{real}} ( b ) = MDCT \{ x ( b ) ⊙ win ( b ) \} \qquad [ Equation 4 ]$$

Here, the real subscript may denote a frequency coefficient of a real transform.

The processor 200 may perform FDNS. The FDNS analysis 1 module 419 may operate in the same manner as the FDNS analysis 2 module 421.

The FDNS analysis 1 module 419 may process a frequency coefficient that is a complex value, and the FDNS analysis 2 module 421 may process a frequency coefficient that is a real value.

The FDNS analysis 1 module 419 and the FDNS analysis 2 module 421 may extract a residual signal by processing a frequency coefficient as shown in Equation 5.

$${rf}_{f} ( b ) = {x}_{f} ( b ) ⊙ \frac{1}{\vert {lp}_{f} ( b ) \vert} , {rf}_{real} ( b ) = {x}_{{f}_{real}} ( b ) ⊙ \frac{1}{\vert {lp}_{f} ( b ) \vert} \qquad [ Equation 5 ]$$

The FDNS analysis 1 module 419 and the FDNS analysis 2 module 421 may extract envelope information from the LPC spectrum, and the envelope information may be used to extract a target residual signal. The output rf_{f}(b) of the FDNS analysis 1 module 419 may be a residual signal having a complex value. The output rf_{f}_{ᵣₑₐₗ} of the FDNS analysis 2 module 421 may be a residual signal having a real value.

The complex TNS analysis module 423 may perform TNS on the residual signal rf_{f}(b) having a complex value. The complex TNS analysis module 423 may obtain an LPC coefficient having a complex value in a frequency domain. The complex TNS analysis module 423 may obtain the LPC coefficient as shown in Equation 6.

$${lp}_{f}^{TNS} ( b ) = LPC \{ {rf}_{f} ( b ) \} \qquad [ Equation 6 ]$$

The complex TNS analysis module 423 may use lp_{f}^{TNS}(b) obtained through Equation 6 to generate a TNS residual signal, which is a secondary residual signal. A process of generating the secondary residual signal may be the same as that of generating an LPC residual signal, and the input signal and the LPC coefficient may be complex values.

The complex TNS analysis module 423 may generate TNS residual signals as shown in Equations 7 and 8.

$${rf}_{f}^{TNS} ( 0 , b ) = {rf}_{f} ( 0 , b ) - {\sum }_{n = 1}^{order} {rf}_{f} ( k - n , b ) * {lp}_{f}^{TNS} ( n , b ) \qquad [ Equation 7 ]$$

$${rf}_{f}^{TNS} ( 0 , b ) = {[ {rf}_{f}^{TNS} ( 0 , b ) , … , {rf}_{f}^{TNS} ( NH - 1 , b ) ]}^{T} \qquad [ Equation 8 ]$$

Here, NH may denote N/2. That is, since the frequency coefficient is complex yet symmetric, the complex TNS analysis module 423 may process only half of data. For example, the complex TNS analysis module 423 may use symmetry, such as [rf_{f}^{TNS}(1,b), . . . , rf_{f}^{TNS}(NH,b)]^{T}=conf([rf_{f}^{TNS}(N−1,b), . . . , rf_{f}^{TNS}(NH+1,b)]^{T}) and thus generate a residual signal.

The residual analysis 1 module 425 may select a residual signal for quantization. The residual analysis 1 module 425 may generate a first switch control signal and control the first switch 429 to select one block from among rf_{f}^{TNS}(b) and rf_{f}(b) that is obtained by performing only FDNS.

Since the smaller amount of information that a residual signal has, the greater quantization efficiency the residual signal has, the residual analysis 1 module 425 may compare the residual signal rf_{f}^{TNS}(b) to the residual signal rf_{f}(b) and thus control the first switch 429 to select a signal having the greater quantization efficiency. Since rf_{f}^{TNS}(b) is a result of performing complex TNS on rf_{f}(b) to reduce the amount of information, rf_{f}^{TNS}(b) may have a smaller amount of information or less energy than rf_{f}(b). The residual analysis 1 module 425 may generate a first switch control signal by comparing two residual signals as shown in Equation 9.

$$complex\_TNS \_gain = 20 {log}_{10} ( \frac{\sum \vert {rf}_{f} ( b ) \vert}{\sum \vert {rf}_{f}^{TNS} ( b ) \vert} ) \qquad [ Equation 9 ]$$

Here, the complex_TNS_gain may be a numerical value indicating the amount of energy reduction after substantially performing the complex TNS. The greater the complex TNS gain, the more effectively the complex TNS may operate. When there is no significant change in the complex TNS gain, the complex TNS gain may have a value close to 0 and it may be determined that there is no additional information reduction caused by the complex TNS.

The example of FIG. 5 may represent a case where a complex TNS gain is large. In the example of FIG. 5, it may be seen that the |rf_{f}^{TNS}(b)| spectrum marked with the solid line is reduced more than the |rf_{f}(b)| marked with the broken line.

As in the example of FIG. 6, when the complex TNS gain is close to 0, it may be seen that there is a dramatic change in spectrum energy even when the complex TNS is applied.

The residual analysis 1 module 425 may monitor the complex TNS gain by using an appropriate threshold value greater than zero and may select an appropriate residual signal. For example, when the complex TNS gain is greater than or equal to 3 dB, the residual analysis 1 module 425 may select |rf_{f}^{TNS}(b)| as a residual signal for quantization. When the complex TNS gain is less than 3 dB, the residual analysis 1 module 425 may select |rf_{f}(b)| as a residual signal for quantization.

When the first switch 429 operates so rf_{f}^{TNS}(b) is selected, the second switch 431 may perform switching so that the complex Q module 433 may automatically perform quantization. The reason why the second switch 431 automatically selects the complex Q module 433 may be to perform complex quantization since rf_{f}^{TNS}(b) is a complex value.

The residual analysis 2 module 427 may generate a second switch control signal for controlling the second switch 431. When rf_{f}(b) is selected by the first switch 429, the residual analysis 2 module 427 may control the second switch 431 to select one residual signal of rf_{f}(b) and rf_{f}_{ᵣₑₐₗ}, considering quantization efficiency.

The residual analysis 2 module 427 may select one of the complex Q module 433 and the real Q module 435 and thus perform complex quantization or real quantization. The residual analysis 2 module 427 may generate a second switch control signal, considering the switching situation of frames before or after a current frame and the information amount of a residual signal.

The residual analysis 2 module 427 may select a block (e.g., a residual signal) having a small number of bits by comparing quantization index entropy bit values after quantization. Alternatively, the residual analysis 2 module 427 may generate a second switch signal to select a block signal having low distortion during restoration after quantization. The second switch control signal may be flag information for determining which block to select from among the two blocks.

A final signal selected by the second switch 431 may be denoted as res_{f}(b). That is, res_{f}(b) may be one of rf_{f}^{TNS}(b), rf_{f}(b), and rf_{f}_{ᵣₑₐₗ}.

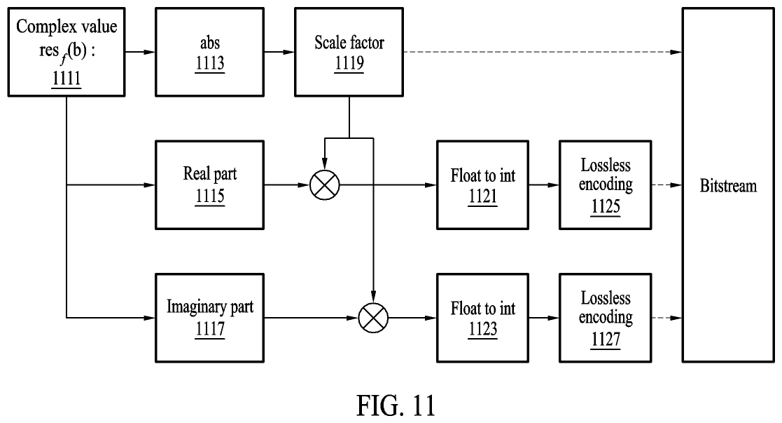

Quantization of the complex Q module 433 and quantization of the real Q module 435 are described in detail with reference to FIG. 11.

The lossless encoding module 437 may generate a bitstream by performing lossless compression on a quantized residual signal.

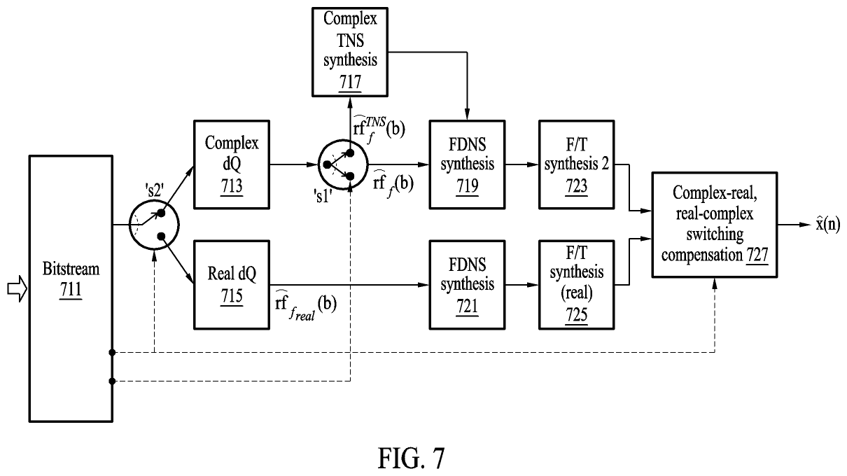

FIG. 7 is an example of implementation of the decoder illustrated in FIG. 3.

Referring to FIG. 7, a processor (e.g., the processor 500 of FIG. 3) may restore an audio signal by decoding a bitstream. The processor 500 may generate an audio signal restored from the bitstream by decoding the bitstream. The decoding process may be a reverse process of the encoding process performed as described with reference to FIG. 4.

The processor 500 may include a first switch, a second switch, a complex dQ module 713, a real dQ module 715, a complex TNS synthesis module 717, an FDNS synthesis module 719, an FDNS synthesis module 721, a frequency-to-time (F/T) synthesis 2 module 723, an F/T synthesis (real) module 725, and a switching compensation module 727.

A first switch s1 and a second switch s2 may perform the same switching operation as the first switch 429 and the second switch 431 of FIG. 4.

The processor 500 may generate a real restoration signal or a complex restoration signal by performing inverse quantization on real data or complex data of a bitstream. The processor 500 may perform inverse quantization by using the complex dQ module 713 and/or the real dQ module 715 and may thus generate the real restoration signal. A real restoration signal [symbol] may be the restoration signal of an encoder's rf_{f} [symbol] (b). The FDNS synthesis module 721 may perform FDNS synthesis on [symbol] without TNS synthesis. The F/T synthesis (real) module 725 may generate a final audio signal by transforming a signal of a frequency domain into a signal of a time domain.

The processor 500 may control the first switch s1 to select one signal of [symbol] ^{(b)} and [symbol] ^{(b)}. The processor 500 may perform complex TNS synthesis and FDNS synthesis on [symbol] ^{(b)} and perform the complex F/T transform after FDNS synthesis so as to generate a final output signal.

The processor 500 may perform FDNS synthesis and F/T synthesis on [symbol] ^{(b)} so as to generate a final output signal.

The processor 500 may generate a complex restoration signal by performing inverse quantization on real data and complex data based on the same scale factor.

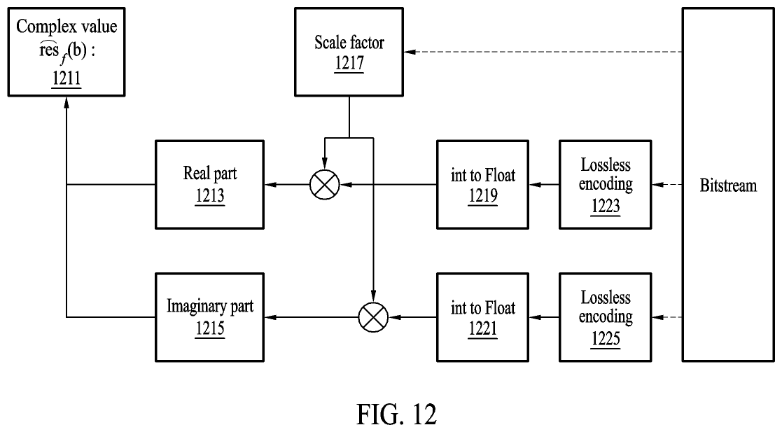

The processor 500 may perform complex inverse quantization or real inverse quantization on a bitstream by controlling the second switch based on the second switch control signal. The processor 500 may perform complex inverse quantization on the bitstream through the complex dQ module 713. The processor 500 may perform real inverse quantization on the bitstream through the real dQ module 715. Hereinafter, an inverse quantization process is described in detail with reference to FIG. 12.

The processor 500 may generate a real FDNS synthesis result or a complex FDNS synthesis result by performing FDNS synthesis on a real restoration signal or a complex restoration signal.

The processor 500 may perform TNS synthesis or FDNS synthesis on the complex restoration signal by controlling the first switch based on the first switch control signal.

When the complex restoration signal is a TNS residual signal, the processor 500 may perform TNS synthesis on the complex restoration signal. The processor 500 may perform FDNS synthesis on the TNS synthesis result.

When the complex restoration signal is an FDNS residual signal, the processor 500 may perform complex FDNS synthesis on the complex restoration signal.

The process of the complex TNS synthesis and FDNS synthesis may be a reverse process of the TNS analysis and FDNS analysis. The FDNS synthesis module 719 and the FDNS synthesis module 721 may perform FDNS synthesis as shown in Equation 10.

$${\hat{x}}_{f} ( b ) = ( b ) ⊙ \vert {lp}_{f} ( b ) \vert , {\hat{x}}_{{f}_{real}} ( b ) = ( b ) ⊙ \vert {lp}_{f} ( b ) \vert \qquad [ Equation 10 ]$$

Here, a hat symbol may denote a quantized signal.

The complex TNS synthesis module 717 may perform TNS synthesis as shown in Equation 11.

$$( 0 , b ) = ( 0 , b ) + {\sum }_{n = 1}^{order} ( k - n , b ) * {lp}_{f}^{TNS} ( n , b ) \qquad [ Equation 11 ]$$

The processor 500 may generate a restored audio signal by performing frequency-to-time transform on a real FDNS synthesis result or a complex FDNS synthesis result.

The F/T synthesis 2 module 723 may perform frequency-to-time synthesis on the FDNS synthesis result of [symbol] ^{(b)} or the result of the complex TNS synthesis + the FDNS synthesis of [symbol] ^{(b)}. The F/T synthesis 2 module 723 may perform Inverse Modified Discrete Cosine Transform (IMDCT) to generate \hat{x}(b).

The F/T synthesis (real) module 725 may perform the IMDCT on the result of the FDNS synthesis module 721 to generate \hat{x}_{tda}(b). The switching compensation module 727 may perform switching compensation on \hat{x}(b) and/or \hat{x}_{tda}(b) to generate a restored audio signal.

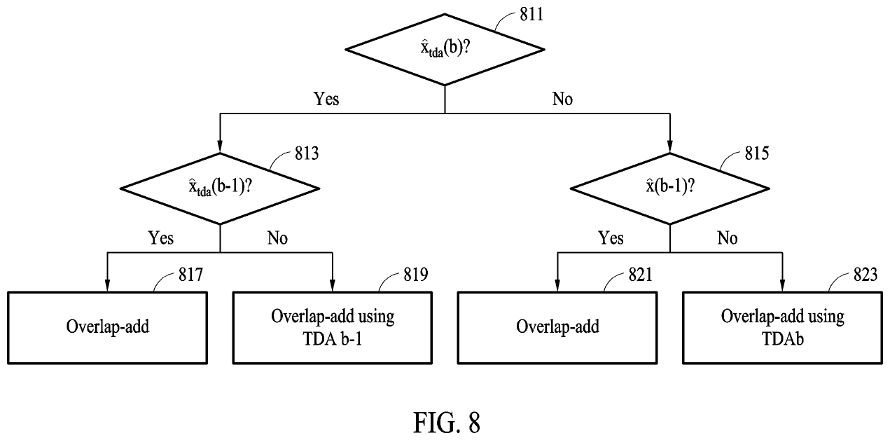

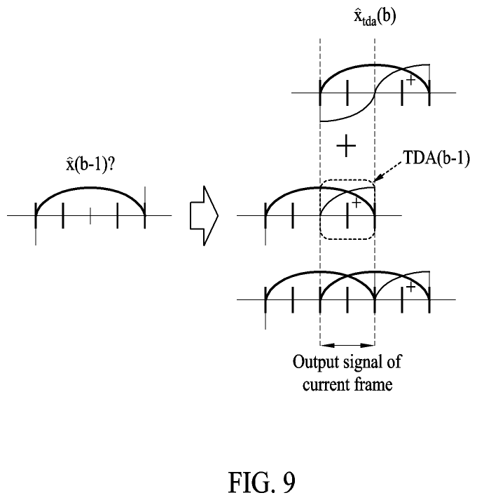

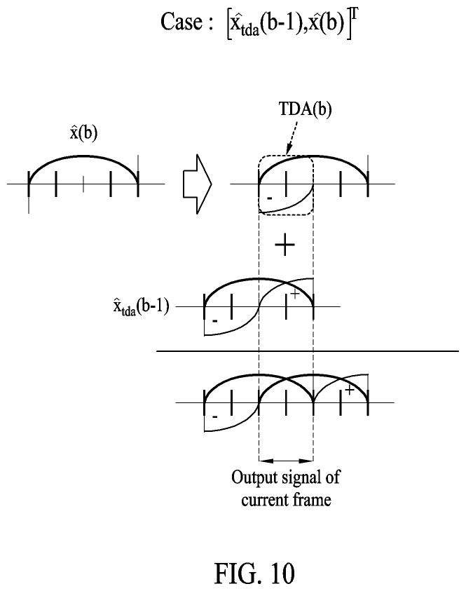

FIG. 8 is a diagram illustrating a switching compensation operation shown in FIG. 7, FIG. 9 is an example of an overlap-add operation, and FIG. 10 is another example of the overlap-add operation.

Referring to FIGS. 8 to 10, a processor (e.g., the processor 500 of FIG. 3) may perform switching compensation on a result of frequency-to-time transform. The switching compensation may refer to an operation of correcting a difference that occurs when frequency-to-time transform processes between blocks are different.

The processor 500 may determine whether a signal corresponding to a current frame of the result of the frequency-to-time transform is a TDA signal. The processor 500 may perform overlap-add based on a result of determining whether the signal is a TDA signal.

The processor 500 may determine whether a signal corresponding to a previous frame of the result of frequency-to-time transform is a TDA signal. The processor 500 may perform overlap-add based on a result of determining whether the signal corresponding to the previous frame is a TDA signal.

The processor 500 may perform switching compensation through a switching compensation module (e.g., the switching compensation module 727 of FIG. 7).

x_{tda}(b) may not be a signal perfectly restored as TDA occurs in a time domain while IMDCT transform is performed. The switching compensation module 727 may remove TDA by performing Time Domain Aliasing Cancellation (TDAC). The switching compensation module 727 may perform overlap-add with \hat{x}_{tda}(b−1), which is a signal at a previous timepoint, to thus remove TDA.

The switching compensation module 727 may perform switching compensation when the time-to-frequency transform method of the previous frame is different from that of the current frame. For example, the switching compensation module 727 may perform switching compensation when a decoded frame sequence is [\hat{x}(b−1), \hat{x}_{tda}(b)]^{T} or [\hat{x}_{tda}(b−1), \hat{x}(b)]^{T}. The switching compensation module 727 may obtain information about the time-to-frequency transform method based on switching information of the second switch.

In operation 811, the switching compensation module 727 may determine whether the restored signal is \hat{x}_{tda}(b). In operation 813, when the restored signal is \hat{x}_{tda}(b), the switching compensation module 727 may determine whether the restored signal of the previous frame is \hat{x}_{tda}(b−1). In operation 817, when the previous frame is a TDA signal, such as \hat{x}_{tda}(b−1), the switching compensation module 727 may offset the TDA by performing simple overlap-add.

In operation 819, when the restored signal of the previous frame is \hat{x}(b−1) that is, a combination with [\hat{x}(b−1), \hat{x}_{tda}(b)]^{T}, the switching compensation module 727 may perform overlap-add using TDA(b−1).

In operation 815, when the restored signal is not \hat{x}_{tda}(b), the switching compensation module 727 may determine whether the previous frame is \hat{x}(b−1). In operation 821, when the previous frame is \hat{x}(b−1), the switching compensation module 727 may perform simple overlap-add. When the previous frame is \hat{x}_{tda}(b−1), the switching compensation module 727 may perform overlap-add using TDA(b).

The examples of FIGS. 9 and 10 may each illustrate a process of performing overlapping by forcibly generating TDA in an overlapping area in a previous frame or a current frame.

FIG. 9 illustrates an example indicating the case of └x(b−1), x_{tda}(b)┘. When a current frame is a TDA frame and a previous frame is a frame having no TDA, the switching compensation module 727 may perform overlap-add by intentionally generating TDA in an overlapping section of the previous frame to transform the generated TDA into the same form as complemental TDA b−1 capable of compensation with the current frame. The example of FIG. 9 may correspond to operation 817 of FIG. 8. FIG. 10 is an example indicating the case of [\hat{x}_{tda}(b−1), \hat{x}(b)]^{T}. When a current frame does not have TDA but a previous frame has TDA, the switching compensation module 727 may perform overlap-add by generating a complementary TDA(b) capable of compensation. The example of FIG. 10 may correspond to operation 823 of FIG. 8.

FIG. 11 is a diagram illustrating a quantization process, and FIG. 12 is a diagram illustrating an inverse quantization process.

Referring to FIGS. 11 and 12, the example of FIG. 11 may be a complex Q module (e.g., the complex Q module 433 of FIG. 4) and/or a real Q module (e.g., the real Q module 435 of FIG. 4), and the example of FIG. 12 may illustrate an inverse quantization operation of a complex dQ module (e.g., the complex dQ module 713 of FIG. 7) and/or a real dQ module (e.g., the real dQ module 715 of FIG. 7).

The complex Q module 433 and/or the real Q module 435 may extract an absolute value 1113, a real part 1115, and an imaginary part 1117, based on res_{f}(b) 1111. The complex Q module 433 and/or the real Q module 435 may perform quantization by extending scalar quantization to the real part 1115 and the imaginary part 1117.

The complex Q module 433 and/or the real Q module 435 may obtain a scale factor 1119 based on the absolute value 1113 of a complex value and may use the obtained scale factor 1119 commonly for the real part 1115 and the imaginary part 1117.

The complex Q module 433 and/or the real Q module 435 may transform real data into integer data. The complex Q module 433 and/or the real Q module 435 may reduce the amount of information by performing float-to-int transform 1121 on the real part 1115. The complex Q module 433 and/or the real Q module 435 may perform float-to-int transform 1123 on the imaginary part 1117 to reduce the amount of information.

The complex Q module 433 and/or the real Q module 435 may reduce the level of each signal by dividing an original signal by the scale factor 1119 and may transform the divided original signal into an integer type to reduce the amount of information.

The complex Q module 433 and/or the real Q module 435 may generate a bitstream by performing lossless encoding 1125 or lossless encoding 1127 on the integer data having a reduced amount of information. The lossless encoding 1125 or the lossless encoding 1127 may perform entropy coding. For example, the entropy coding may include Huffman coding and arithmetic coding.

The inverse quantization process of FIG. 12 may be the reverse process of the quantization process. The complex dQ module 713 and/or the real dQ module 715 may perform lossless encoding 1223 or lossless encoding 1225 on a bitstream. The complex dQ module 713 and/or the real dQ module 715 may perform integer-real transform by performing int-to-float transform 1219 or int-to-float transform 1221 on a lossless encoding result.

Similar to the quantization process, the complex dQ module 713 and/or the real dQ module 715 may use a transmitted scale factor 1217 commonly for a real part 1213 and an imaginary part 1215 to generate a complex value [symbol] ^{(b)} 1211.

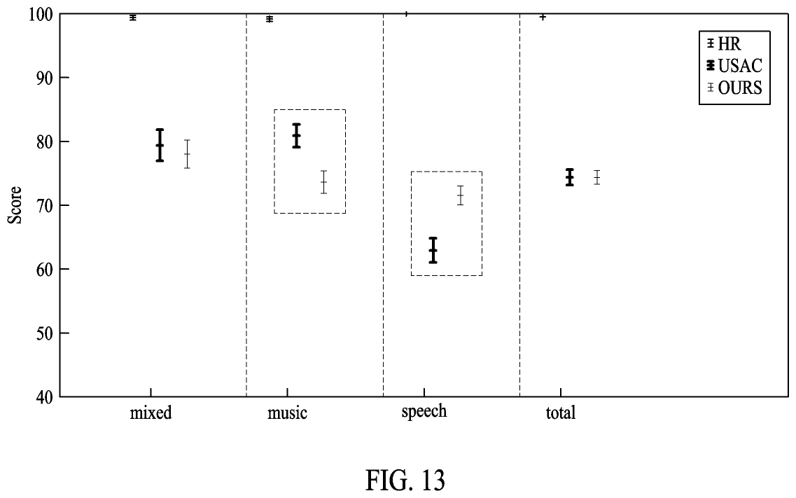

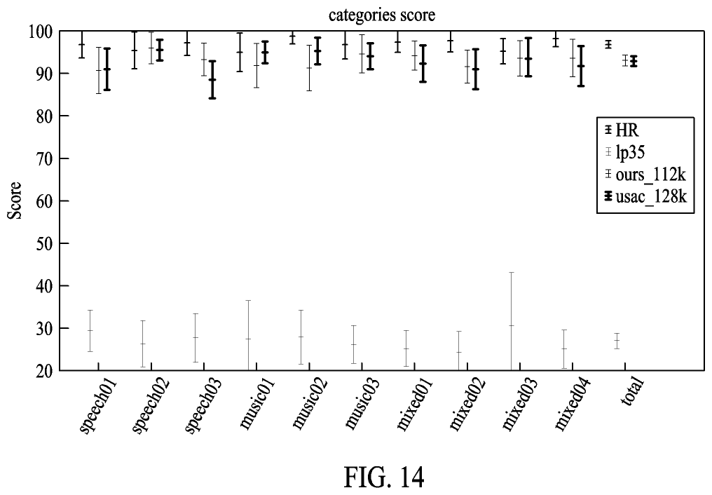

FIG. 13 is an example of performance of an audio processing device, and FIG. 14 is another example of performance of the audio processing device.

Referring to FIGS. 13 and 14, an audio processing system (e.g., the audio processing system 10 of FIG. 1) may be compared in performance to the TCX80 mode of Unified Speech Audio Coding (USAC). TCX80 may be a Linear Prediction Domain (LPD) coding mode of USAC and may be a coding scheme in which only FDNS is applied to an MDCT area.

The audio processing system 10 may encode a complex coefficient value while performing encoding, using complex FDNS and complex TNS, so that the audio processing system 10 may perform encoding and decoding more effectively than USAC encoding.

The example of FIG. 13 may illustrate a listening test result for a low bit rate of 16 kbps/channel, and the example of FIG. 14 may show a listening test result for a high bit rate. The listening test result is test data of a total of 6 people, and may be represented by using a 95% confidence interval of an average score. A performance evaluation environment may be shown in Table 1.

TABLE 1

| | |
|---|---|
| Evaluation environment | Adopted items |
| Evaluation method | MUSRHA |
| Subject | 14 people |
| Test item | 10 items (speech(3), music(3), and |
| | mixed(4)) |
| Evaluation system | Hidden Reference (HR) |
| | lp35: Anchor (low-pass-filter 3.5 kHz) |
| | ours_112k: DES-based audio encoder |
| | usac_128k: USAC audio encoder |
| Sampling frequency | 48 kHz |
| Bit rate | ours_112k: 112 kbps stereo |
| | usac_128k: 128 kbps stereo |

Here, HR may represent original sound. A Moving Picture Experts Group (MPEG) test item may be used as a test item. Results may be obtained by integrating test items for each category of ‘music’, ‘speech’, and ‘mixed (speech+music)’. It may be seen that there is a significant performance improvement for speech at low bit rates.

Compression efficiency may clearly improve for stereo contents at high bit rates. Considering the 95% confidence interval for a final average, it may be confirmed that the two systems exhibit equivalent performance of sound quality. Accordingly, it may be confirmed that the audio processing system 10 may provide equivalent audio quality even though the audio processing system 10 has a bit reduction of 12.5% compared to the current USAC technique.

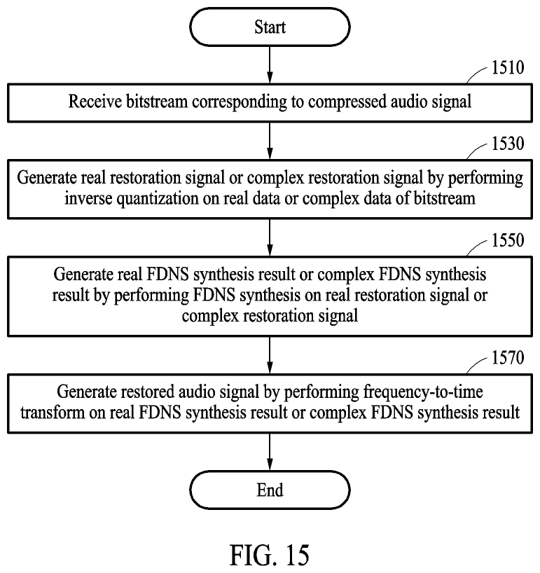

FIG. 15 is a flowchart of an operation of the decoder illustrated in FIG. 1.

Referring to FIG. 15, in operation 1510, a receiver (e.g., the receiver 400 of FIG. 3) may receive a bitstream corresponding to a compressed audio signal. In operation 1530, a processor (e.g., the processor 500 of FIG. 3) may generate a real restoration signal or a complex restoration signal by performing inverse quantization on real data of the bitstream or complex data of the bitstream.

The processor 500 may generate the complex restoration signal by performing inverse quantization on the real data and complex data based on the same scale factor.

The processor 500 may perform complex inverse quantization or real inverse quantization on the bitstream by controlling a second switch based on a second switch control signal.

In operation 1550, the processor 500 may generate a real FDNS synthesis result or a complex FDNS synthesis result by performing FDNS synthesis on the real restoration signal or the complex restoration signal.

The processor 500 may control a first switch based on a first switch control signal and may thus perform TNS synthesis or FDNS synthesis on the complex restoration signal.

When the complex restoration signal is a TNS residual signal, the processor 500 may perform TNS synthesis on the complex restoration signal. The processor 500 may perform FDNS synthesis on a TNS synthesis result.

When the complex restoration signal is an FDNS residual signal, the processor 500 may perform complex FDNS synthesis on the complex restoration signal.

In operation 1570, the processor 500 may generate a restored audio signal by performing frequency-to-time transform on the real FDNS synthesis result or the complex FDNS synthesis result.

The processor 500 may perform switching compensation on a result of the frequency-to-time transform. The processor 500 may determine whether a signal corresponding to a current frame of the result of the frequency-to-time transform is a TDA signal. The processor 500 may perform overlap-add based on the result of determining whether the signal is a TDA signal.

The processor 500 may determine whether a signal corresponding to a previous frame of the result of the frequency-to-time transform is a TDA signal. The processor 500 may perform overlap-add based on the result of determining whether the signal corresponding to the previous frame is a TDA signal.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. An audio signal processing device comprising:
a receiver configured to receive a bitstream corresponding to a compressed audio signal; and
a processor configured to:
generate a real restoration signal or a complex restoration signal by performing inverse quantization on real data of the bitstream or complex data of the bitstream;
generate a result of real Frequency Domain Noise Shaping (FDNS) synthesis or a result of complex FDNS synthesis by performing FDNS synthesis on the real restoration signal or the complex restoration signal; and
generate a restored audio signal by performing frequency-to-time transform on the result of the real FDNS synthesis or the result of the complex FDNS synthesis.

2. The audio signal processing device of claim 1, wherein the processor is configured to generate the complex restoration signal by performing the inverse quantization on the real data and the complex data, based on a same scale factor.

3. The audio signal processing device of claim 1, wherein the processor is configured to perform Temporal Noise Shaping (TNS) synthesis or the FDNS synthesis on the complex restoration signal by controlling a first switch based on a first switch control signal.

4. The audio signal processing device of claim 3, wherein, when the complex restoration signal is a TNS residual signal, the processor is configured to perform the TNS synthesis on the complex restoration signal and perform the FDNS synthesis on a result of the TNS synthesis.

5. The audio signal processing device of claim 1, wherein, when the complex restoration signal is an FDNS residual signal, the processor is configured to perform the complex FDNS synthesis on the complex restoration signal.

6. The audio signal processing device of claim 1, wherein the processor is configured to perform complex inverse quantization or real inverse quantization on the bitstream by controlling a second switch based on a second switch control signal.

7. The audio signal processing device of claim 1, wherein the processor is configured to perform switching compensation on a result of the frequency-to-time transform.

8. The audio signal processing device of claim 7, wherein the processor is configured to:
determine whether a signal corresponding to a current frame of the result of the frequency-to-time transform is a Time Domain Aliasing (TDA) signal; and
perform overlap-add based on a result of determining whether the signal is the TDA signal.

9. The audio signal processing device of claim 8, wherein the processor is configured to:
determine whether a signal corresponding to a previous frame of the result of the frequency-time transform is the TDA signal; and
perform the overlap-add based on a result of determining whether the signal corresponding to the previous frame is the TDA signal.

10. A method of processing an audio signal, the method comprising:
receiving a bitstream corresponding to a compressed audio signal;
generating a real restoration signal or a complex restoration signal by performing inverse quantization on real data of the bitstream or complex data of the bitstream;
generating a result of real Frequency Domain Noise Shaping (FDNS) synthesis or a result of complex FDNS synthesis by performing FDNS synthesis on the real restoration signal or the complex restoration signal; and
generating a restored audio signal by performing frequency-to-time transform on the result of the real FDNS synthesis or the result of the complex FDNS synthesis.

11. The method of claim 10, wherein the generating of the real restoration signal or the complex restoration signal comprises generating the complex restoration signal by performing inverse quantization on the real data and the complex data based on a same scale factor.

12. The method of claim 10, wherein the generating of the result of the real FDNS synthesis or the result of the complex FDNS synthesis comprises performing Temporal Noise Shaping (TNS) synthesis or the FDNS synthesis on the complex restoration signal by controlling a first switch based on a first switch control signal.

13. The method of claim 12, wherein the performing of the TNS synthesis or the FDNS synthesis on the complex restoration signal comprises:
when the complex restoration signal is a TNS residual signal, performing the TNS synthesis on the complex restoration signal; and
performing the FDNS synthesis on a result of the TNS synthesis.

14. The method of claim 10, wherein the generating of the result of the real FDNS synthesis or the result of the complex FDNS synthesis comprises performing the complex FDNS synthesis on the complex restoration signal when the complex restoration signal is an FDNS residual signal.

15. The method of claim 10, wherein the generating of the real restoration signal or the complex restoration signal comprises performing complex inverse quantization or real inverse quantization on the bitstream by controlling a second switch based on a second switch control signal.

16. The method of claim 10, further comprising performing switching compensation on a result of the frequency-to-time transform.

17. The method of claim 16, wherein the performing of the switching compensation comprises:
determining whether a signal corresponding to a current frame of the result of the frequency-time transform is a Time Domain Aliasing (TDA) signal; and
performing overlap-add based on a result of determining whether the signal is the TDA signal.

18. The method of claim 17, wherein the performing of the overlap-add based on the result of determining whether the signal is the TDA signal comprises:
determining whether a signal corresponding to a previous frame of the result of the frequency-to-time transform is the TDA signal; and
performing the overlap-add based on a result of determining whether the signal corresponding to the previous frame is the TDA signal.

19. A non-transitory computer-readable storage medium storing instructions that, when executed by a processor, cause the processor to perform the method of claim 10.

20. An audio signal processing device comprising:
a receiver configured to receive an audio signal; and
a processor configured to:
generate a real transform spectrum or a complex transform spectrum by performing time-to-frequency transform on the audio signal;
generate a real residual signal or a complex residual signal by performing Frequency Domain Noise Shaping (FDNS) analysis on the real transform spectrum or the complex transform spectrum; and
generate a bitstream corresponding to a compressed audio signal by performing quantization on the real residual signal or the complex residual signal.
